(19) United States
(12) Patent Application Publication
(10) Pub. No.: US 2014/0209377 A1
(43) Pub. Date: Jul. 31, 2014

(54) CONNECTOR STRUCTURE

(71) Applicant: Yazaki Corporation, Tokyo (JP)

(72) Inventor: Feng Wang, Kakegawa-shi (JP)

(73) Assignee: Yazaki Corporation, Tokyo (JP)

(21) Appl. No.: 14/161,862

(22) Filed: Jan. 23, 2014

(30) Foreign Application Priority Data
Jan. 28, 2013 (JP) 2013-012863

(51) Int. Cl. H02G 15/013

(52) U.S. Cl. CPC H02G 15/013
USPC 174/658

(57) ABSTRACT

Disclosed is a connector structure keeping its waterproof property. Outside the first seal member closely contacting a shield connector and a shield electrical wire, tightening by a tightening member the shield electrical wire restricts an outer insulating cover of the shield electrical wire tightened and deformed by the seal member from being pressed outward. Tightening the shield electrical wire by the tightening member restricts the outer insulating cover deformed by the first seal member from moving and a so-called thinness of the cover of the electrical wire, enabling waterproof property to be maintained.

### TECHNICAL FIELD

This invention relates to connector structures for connecting electrical wires that are passed through from one end toward the other end of a connection object to the connection object.

### BACKGROUND ART

Conventionally, as a structure of an electrical wire connecting devices to each other, for example, in an automobile (e.g., an electric vehicle or a hybrid vehicle), devices such as a motor, a battery, or inverter are connected to each other with a shield electrical wire, and a connector structure has been advocated for ground connecting this shield electrical wire and a case of the devices (e.g., see the PTL 1 listed below). A shield connector structure 100 recited in the PTL 1 is designed to connect a shield electrical wire 1 and a metal case as a connection object, and to waterproof its connection part. The shield electrical wire 1 is a coaxial cable provided with a conductor 2, an inner insulating cover 3 covering around the conductor 2, a shield member 4 disposed around the inner insulating cover 3 and made of such braided conductor, and an outer insulating cover 5 covering around the shield member 4. The metal case 6 is provided with a insertion hole 7 passing therethrough, the shield electrical wire 1, and a bolt hole 8 into which a bolt 106 is threaded that fixes the housing 101.

This shield connector structure 101 is provided with a housing 101 passing therethrough the shield electrical wire 1 and fixed to the metal case 6, a shield member 102 electrically connecting the shield part 4 of the shield electrical wire 1 and the metal case 6, a first seal member 103 inserted into between an inner face of the shield electrical wire 102 and an outer face of an outer insulating cover 5 of the shield electrical wire 1, a second seal member 104 inserted into between an outer face of the shield member 102 and an inner face of the insertion hole 7 of the metal case 6, a shield pipe 105 covering the shield part 4 connected to the shield member 102, and a bolt 106 fixing the housing 1 to the metal case 6.

The housing 101 is fixed to one side (outer side) of the metal case 6, crimps and holds the shield member 102 between the metal case 6 and the housing 101, and is provided with a insertion part 111 passing therethrough the shield electrical wire 1, a tubular prelection 112 extending toward the other side (inner side) of the metal case 6 beyond the insertion part 111 and entering into the insertion hole 7, and a flange 113 extending outward, in a radial direction of the insertion part 111 and fixed to the metal case 6.

The first seal member 103 is formed of elastic material such as rubber and into generally tubular shape, includes an annular lip part with concave-convex on its outer and inner faces, has a plurality of rips on the inner face closely contact an outer face of the outer insulating cover 5 of the shield electrical wire 1, a plurality of rips on the outer face closely contact shield member 102 and each of inner faces of the tubular projection 112 of the housing 101, and thereby seals between the shield electrical wire 1 and the shield member 102 or the housing 101.

As mentioned above, in the conventional shield connector structure 100 recited in the PTL 1 the shield electrical wire 1 is electrically connected to the metal case 6 by the housing 102, the shield member 4 is electrically ground connected through the shield part 4 to the metal case 6. Furthermore, seal by the first seal member 103 and the second seal member 104 waterproofs connection part of the shield electrical wire 1 and the metal case 6, and thus prevents water from leaking inward from outside the metal case 6.

### CITATION LIST

### [Patent Literature]

### [PTL 1]

Japanese Patent Application Laid-open Publication No. 2000-234344

### SUMMARY OF INVENTION

### [Technical Problem]

Disadvantageously, the conventional shield connector structure recited in the PTL 1, in order to retain waterproof property, uses the first seal member 103 tightly fastening the shield electrical wire 1, and thereby the outer insulating cover 5 of the first seal member 103 is liable to deform because the first seal member 103 tightly fastens the shield electrical wire 1, the outer insulating cover 5 is, as shown in FIG. 8, pressed out to move toward outside or inside the metal case 6 beyond the first seal member 103, a diameter of the electrical wire at the first seal member 103 becomes reduced, that is, thinness of the cover of the electrical wire is induced, and consequently, close contact between the first seal member 103 and the shield electrical wire 1 becomes so loosed as waterproof property becomes deteriorated.

The object of the invention is, in view of drawbacks as mentioned above, to provide a connector structure to retain waterproof property.

### Solution to Problem

In order to resolve the problems mentioned above, there is provided, a connector for passing an electrical wire having a conductor and an insulating cover through an insertion hole of a connection object from one side to the other side, and connecting the electrical wire to the connection object, the connector including: a housing having the electrical wire passed therethrough, fixed to the connection object at the one side, and including a housing body, a fixing part adapted to be fixed to the connection object, and an electrical wire guide part passing the electrical wire through the housing body from the one side to the other side; a seal member inserted between an inner face of the housing and an outer face of the electrical wire and including a first close contact part formed into a tubular shape along the electrical wire, and closely contacting an outer peripheral face of the electrical wire, a second close contact part closely contacting an inner peripheral face of the housing body; and a tightening member crimping the electrical wire at the one side of the seal member, and including an annular part pressing the insulating cover of the electrical wire by reducing the diameter of the annular part by crimping, the annular part being located inside the electrical wire guide part.

According to the invention, by crimping the tightening member with the electrical wire in the one side of the seal member the cover of the electrical wire tightened to the seal member is not pressed out toward the one side, and thus making it possible to prevent thinness of the cover of the electrical wire.

Preferably, the tightening member includes a flange abutting from the other side onto a side face of the electrical wire guide part.

According to the connector structure, since the flange of the4 tightening member abuts onto the electrical wire guide to regulate movement toward the one side of the electrical wire, it is made possible for the electrical wire to drop out from the connection object or the housing even though the electrical wire is bent, or pulled, out.

Preferably, the connector further includes an other side tightening member crimping the electrical wire at the other side of the seal member.

According to this structure, since in the other side of the seal member, the other side tightening member tightens the electrical wire, the cover of the electrical wire tightened by the seal member is not pressed out toward not only the one side but the other side, making it possible to further prevent thinness of the cover of the electrical wire, and thereby to maintain its waterproof property.

Preferably, the electrical wire is a shield wire including a shield part, disposed outside the insulating cover, and an outer insulating cover disposed outside the shield, member, and includes a conductive and tubular shield, member connecting the seal member and the connection object, and wherein the other side tightening member is a pressure-bonding member crimping and fixing the shield member and the electrical wire.

According to such configuration, the tightening member and the other side tightening member crimp the electrical wire at the one side and at the other side of the electrical wire across the seal member, and thus it is made possible to prevent at the shield connector as well seal pressure reduction induced by thinness of the cover of the electrical wire, and to maintain waterproof property.

### [Advantageous Effects of Invention]

According to the connector structure of the invention, since the tightening member crimps the electrical wire where the seal member is located adjacent, and thus the thinness of the cover of the electrical wire can be prevented, it is made possible to maintain waterproof property for a long period.

### BRIEF DESCRIPTION OF DRAWINGS

FIG. 1 is a cross-sectional view illustrating a connector structure according to one embodiment of the invention;

FIG. 2 is a perspective view illustrating an electrical wire of the connector structure;

FIG. 3 is a perspective view seen from one side of a connection object of the connection structure;

FIG. 4 is a cross-sectional view illustrating a tightening member of the connection structure;

FIG. 5 is a perspective view illustrating the tightening member;

FIG. 6 is a partial cross-sectional view illustrating an exploded portion of the connector structure;

FIG. 7 is a cross-sectional view of a connector structure according to conventional technology; and

FIG. 8 is an exploded cross-sectional view illustrating a portion of the connector structure according the conventional technology.

### DESCRIPTION OF EMBODIMENTS

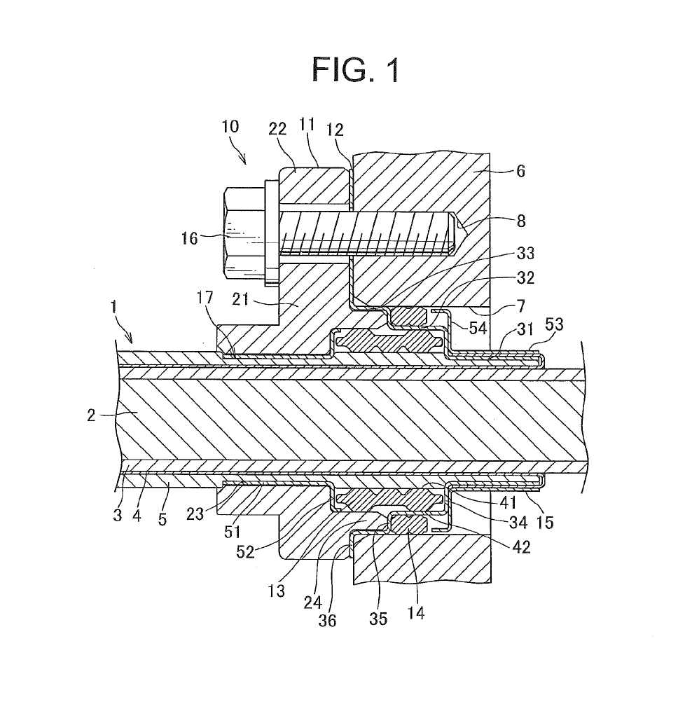

Referring FIGS. 1 to 6, a connector structure according to one embodiment of the invention is hereinafter discussed. The connector structure of the embodiment is what is adapted to connect a shield electrical wire 1 to ground and to waterproof this connection part when connecting using the shield electrical wire 1 between the motor and an inverter or between the inverter and a battery in an electric vehicle running with a drive force of a electric motor or a hybrid vehicle running with a drive force of both an engine and an electric motor.

As shown in FIG. 1, the shield electrical wire 1 is a coaxial cable provided with a conductor 2 made of braided wire that is made such that a plurality of wires are braided, an insulating cover 3 covering circumference of the conductor 2 and made of insulating synthetic resin, a shield part 4 disposed around the insulating conductor 3 and made of conductor such as braided wire, and an outer insulating cover 5 covering circumference of the shield part 4 and made of such insulating synthetic resin. The connection object such as a motor, an inverter, and a battery includes a metal case 6 composing its outer, and is provided with a insertion hole 7 passing therethrough the shield electrical wire 1.

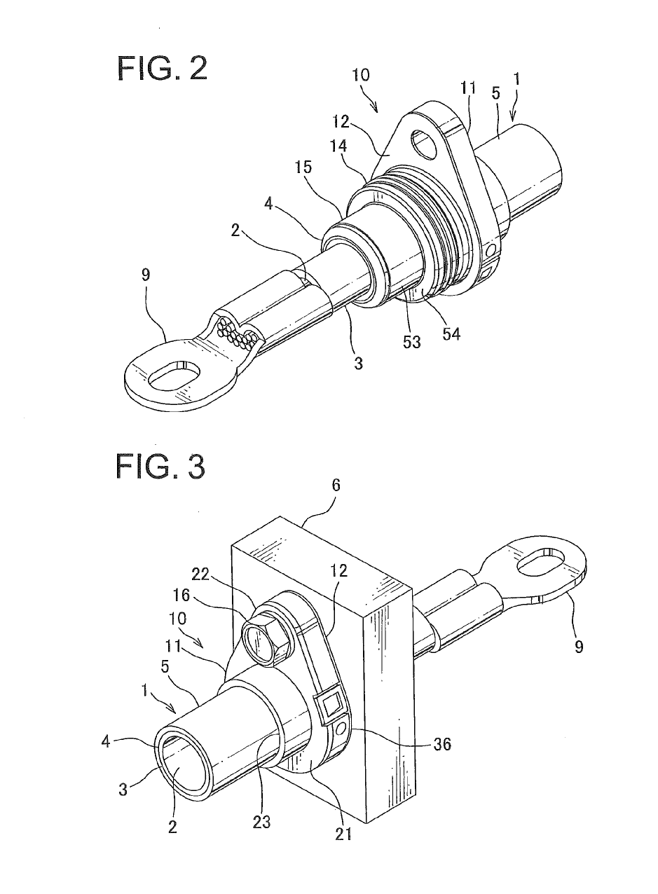

The shield electrical wire 1 is inserted from an outside of the metal case 6 (one side) into an inside thereof (the other side)through the insertion hole 7 as shown in FIGS. 1 and 2, and a terminal fitting 9 is fixed to the conductor 2 at an inside tip, which the terminal fitting 9 is connected to a not-shown electrical connection part within the metal case 6, The shield part 4 of the shield electrical wire 1 allows the outer insulating cover 5 at its tip to be removed so as to be exposed, and is ground connected to the metal case 6 through shield member 12 mentioned below, and these shield part 4 and the shield member 12 block electromagnetic wave, and prevent leak or penetration of noise.

The connector 1 is as shown in FIGS. 1 to 3, provided with a housing 11 passing therethrough the shield, electrical wire 1 and fixed to an outside of the metal case 6, the conductive and tubular shield member 12 connecting the shield part 4 and the metal case 6, a first shield member 13 inserted between the inside of the shield member 12 and the outside of the outer insulating cover 5 of the shield electrical wire 1, a second seal member 14 inserted between the outside of the seal member 12 and the inside of the insertion hole 7 of the metal case 6, an annular shield pipe 15 (an other side tightening member, or tightening member) crimping the shield part 4 of the shield electrical wire 1 and the shield member 12 to fix, and a bolt 15 for fixing the housing 11 to the metal, case 6.

The housing 11 is a die-cast member formed integrally of metal such as aluminum alloy, and provide with a housing body 21 nipping and conducting the shield member 12 with respect to the metal case 6, a fixing part 22 fined from outside the metal case 6 to the metal case 6, an electrical, wire guide 23 passing through the housing body 21 and inserting therein the shield electrical wire lf and a tubular extension 24 extending from, the housing body 21 into the insertion hole 7 of the metal case 6 and located inside the shield member 12. Note that the housing 11 is not limited to metal material but may be made of synthetic resin as far as to hold the shield member 12 and the first seal member 13.

The shield member 12 is made of conductive material, and is formed into a tubular shape with steps so as its diameter becomes large in three steps from inside toward outside of the metal case 6. E.g., as also shown in FIG. 6, the shield member 12 is provided with a first tubular part 31 to be connected to the shield part 4 of the shield electrical wire 1, a second tubular part 32 located at nearer side of the housing 11 (the one side, or an outer side of the metal case 6) than the first tubular part 31 with its diameter larger, a third tubular part 33 located at further nearer one side that the second tubular part 32 with its diameter larger, a first step 34 connecting the first tubular part 31 to the second tubular part 32, a second step 35 connecting the second tubular part 32 to the third tubular part 33, and a third step 36 continuous with the third tubular part 33 and bent to follow along outside the metal case 6.

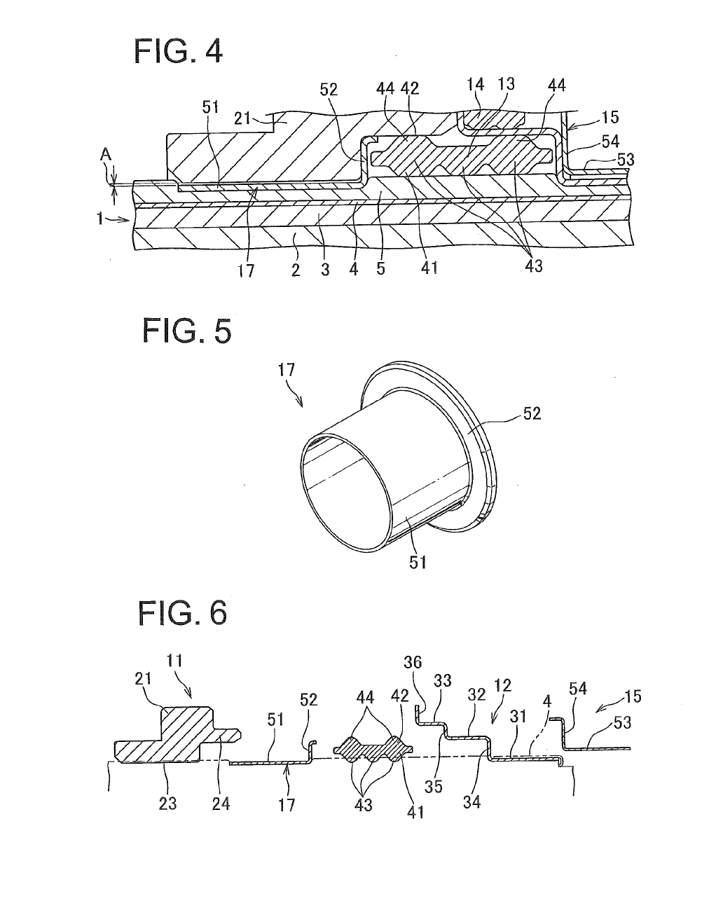

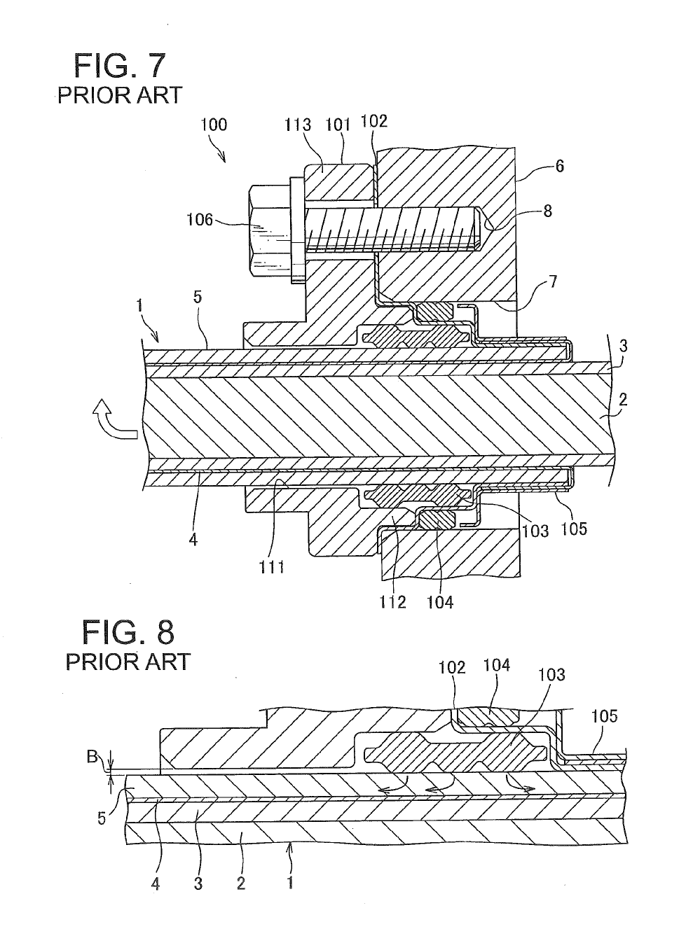

The first shield, member 13 is as shown in FIGS. 4 and 6, formed of elastic material such as rubber into a throughout tubular shape, and is provided with a first close contact part 41 closely contacting outer peripheral face of the outer insulating cover 5 along the shield electrical wire 1, and a second close contact part 42 closely contacting inner peripheral face of the extension 24 and the second tubular part 32. The first close contact part 41 of the first seal member 13 is provided with annular rips 43 of three strips, which are pressed and thrust to the outer peripheral face of the outer insulating cover 5, thereby sealing a gap spaced from the shield electrical wire 1. The second close contact 42 is also provided with annular rips 44 of two strips, which are pressed and thrust to inner peripheral faces of the extension 24 and the second tubular part 32, thereby sealing gaps from the housing 21 and from the shield member 12.

The seal member 14 is formed of elastic material such as rubber and into a throughout tubular shape, and is provided with annular rips of two strips on an inner peripheral face and an outer peripheral face thereof, which the annular rips on the inner peripheral face is pressed and thrust to the outer peripheral face of the second annular part 32, thereby sealing a gap spaced from the shield member 12, and which the annular rips on the outer peripheral face is pressed and thrust to the inner peripheral face of the insertion hole 7, thereby sealing a gap spaced from the metal case 6.

As mentioned above, inside the insertion hole 7, as shown in FIG. 4, from the outer peripheral face of the outer insulating cover 5 toward the outer peripheral face 7 outside the metal case (the one side), the first close contact part 41 of the first seal member 13, the second close contact part 42 of the first seal member 13, the extension of the housing 11, and the third tubular part 33 are subsequently and coaxially located, and inside the metal case (the other side) the first close contact 41 of she first seal member 13, the second close contact part 42 of the first seal member 13, the second tubular part 32 of the shield member 12, and the second seal member 14 are coaxially located, and by those adjacent to each other in a radial direction being close contacted, the shield electrical wire 1 is connected to the metal case 6 with waterproofed.

The shield electrical wire 1 is also in the outer side of the metal case 5 (the one side) adjacent to the first shield member 13, tightened by a metallic tightening member 17, and in the inside of the seal member (the other side) tightened by a metallic tightening shield pip 15. The tightening member 17 is reduced in its diameter by crimping, provided with an outer annular part 51 pressing the insulating cover of the electrical wire, and an outer flange 52, and shuts onto a side inside the the electrical wire guide 23 from inside (the other side). The shield pips 15 includes an inside annular part 53, and an inside flange 54, and the shield electrical wire 1 and the first tubular part 31 of the shield member 12 are crimped by the inside annular part 53 to fix, as well as abut onto the first step part 34 of the shield member 12 by the inside flange 54 from the inside (the other side) of the metal case.

Then, an assembling procedure of the shield electric case 1 to the metal case 6 is discussed. Note that since an assembling procedures of the shield electrical wire 1 are such that after assembling, the shield connector 1 is only configured as shown in FIG. 1 but not limited to what, is described hereinafter, each procedure may not be subsequently implemented.

Firstly, the shield electrical wire 1 preliminarily cut by predetermined length is subsequently passed through the housing body 21, tightening member 17, the first seal member 13, and the shield member 12. The outer insulating cover 5 is removed at a tip of the shield electrical wire 1, the exposed shield part 4 is cut and folded to be overlaid onto the outer peripheral of the first annular part 31 of the shield member 12, then the shield pipe 15 overlaid on the outside of the folded shield part 4 is crimped to be fixed, and the shield member 12 is fixed to the tip side of the shield electrical wire 1 to tighten the shield electrical wire 1. Then, the first seal member 13 is moved toward the tip side of the shield electrical wire 1, the first seal member 13 is press fitted into a cap between the outer insulating cover 5 and the second tubular part 32 of the shield member 12. It follows from this that the first close contact 41 of the first seal member 13 is closely contacted, with the outer insulating cover 5 of the shield electrical wire 1 and that the second close contact 42 is closely contacted with the inside of the second annular part 32.

Then, the tightening member 17 is moved toward the tip of the shield electrical wire 1, the outer annular part 51 of the tightening member 17 is crimped, to be press fitted to the shield electrical wire 1, and thereby the shield electrical wire 1 is tightened, furthermore, the housing body 21 is moved to engage the shield member 12 and the first seal member 13. It follows from this that the housing body 21 of the housing 11 and the fixing part 22 abut onto the the third, step 36 of the shield member 12, and the outer flange 52 of the tightening member 17 abuts onto inside of the electrical wire guide part 23.

Then the second seal member 14 is press fitted into an cuter peripheral of the second tubular part 32 of the shield member 12 from tip side of the shield electrical wire 1. And the terminal fitting 9 is preliminarily crimped with the exposed conductor 2 where the inner insulating cover 3 is removed.

As shown in FIG. 2, by the aforementioned way, attached to the tip of the shield electrical wire 1 are the housing 11, the shield member 12, the first shield member 13, the second seal member 14, and the shield pipe 15, and the shield electrical wire 1 as it is is inserted from a side of the terminal fitting 9 into the insertion hole 7 of the metal case 6. Then while the second seal member 14 slides and contacts onto the inner peripheral face of the insertion hole 7, the shield electrical wire 1 is pressed and the third tubular part 33 of the shield member 12 is inserted into the insertion hole 7, the third step 36 of the shield member 12 abuts onto outside the metal case 6. Then the bolt 16 inserted into the fixing part 22 of the housing 11 is threaded into the bolt hole S of the metal case 6, the housing body 21 and the fixing part 22 nip the third step 36 to the outside of the metal case 6, making the shield member 12 connected to the metal case 6, assembling the shield electrical wire 1 is completed.

According to the embodiment, outside the first seal member 13 the tightening member 17 tightens the shield electrical wire 1, and thereby the outer insulating cover 5 of the shield electrical wire 1 tightened and deformed by the seal member 13 is restricted from being pressed outward. Therefore, tightening the shield electrical wire 1 by the tightening member 17 restricts the outer insulating cover 5 deformed by the first seal member 13 from moving and the outer diameter of the shield electrical wire 1 where the first seal member 13 is located from reducing, which is so-called thinness of the cover of the electrical wire 1, a seal, pressure between the first seal member 13 and the shield electrical wire 1 can be kept, and waterproof property can also be maintained.

Furthermore, in the embodiment, the outer flange 52 of the tightening member 17 abuts onto the side of the inside of the electrical wire guide part 23 from inside, outward movement of the shield electrical wire 1 is restricted, making it possible to prevent removal of the shield electrical wire from the metal case 5 even though the shield electrical wire 1 is bent or strained.

Furthermore, in the embodiment, crimping and press fitting the shield pipe 15 to the shield electrical wire 1 prevents the outer insulating cover 5 of the shield, electrical wire 1 from, being pressed out not only outward but inward. Therefore, it is made possible to reduce thinness of seal portion of the electrical wire by the first seal member 13, and thus to keep waterproof property for long period.

Furthermore, in the embodiment, the tightening member 17 Is made of metal, allowing to be manufactured to higher accuracy than polyethylene that is used for cover for the shield electrical wire 1, which makes individual difference in an outer diameter of the outer annular part 51 of the tightening member 17 manufactured smaller than the shield electrical wire 1, and also makes individual difference in outer diameter upon the tightening member 17 tightening the shield electrical wire 1. Therefore, in gaps A and B between the shield electrical wire 1 and the electrical wire guide part 7 of housing 11 as shown in FIGS. 4 and 8, respectively, it is made possible to make the gap A of the present embodiment smaller than the conventional gap B. It follows from this that when the shield electrical wire 1 is bent in its outside, deterioration of seal pressure at opposite side in a bending direction can be reduced.

Note that in the aforementioned embodiment, the shield electrical wire 1 that is made of coaxial cable is exemplified as an electrical wire, but a connector structure made of those other than the shield electrical wire is available for the present invention. In this case, the part 12 can be omitted, but those similar to the tightening member 17 as the other side member can be used.

Furthermore, as connecting object such as, but not limited to, the motor, the inverter, the battery, or other adequate electric devices or electrical junction box having electric parts therein are available.

Additionally, the best configuration or method for implementing the invention are disclosed therein, to which the invention is but not limited to. Namely, it is to be understood that various changes and modifications will be apparent to those skilled in the art. Therefore, unless otherwise such changes and modifications depart from the scope of the present invention hereafter defined, they should be construed as being included therein.

Therefore, since what is described herein to limit configuration or material is exemplified to readily understand the invention, but not intended to define the invention, descriptions using parts name beyond partial or whole definition of this configuration or material should be included in the invention.

### REFERENCE SIGNS LIST

1 shield electrical wire (electrical wire)
2 conductor
3 inner insulating cover (insulating cover)
4 shield part
5 outer insulating cover
6 5 metal case
7 insertion hole
11 housing
12 shield member
13 first seal member (seal member)
15 shield pipe
17 tightening member
21 housing body
22 fixing part
23 electrical wire guide part
41 first close contact part
42 second close contact part
51 outer annular part
52 outer flange (flange part)

1. A connector for passing an electrical wire having a conductor and an insulating cover through an insertion hole of a connection object from one side to the other side, and connecting the electrical wire to the connection object, the connector comprising:
a housing having the electrical wire passed therethrough, fixed to the connection object at the one side, and including
a housing body,
a fixing part adapted to be fixed to the connection object, and
an electrical wire guide part passing the electrical wire through the housing body from the one side to the other side;
a seal member inserted between an inner face of the housing and an outer face of the electrical wire and including
a first close contact part formed into a tubular shape along the electrical wire, and closely contacting an outer peripheral face of the electrical wire,
a second close contact part closely contacting an inner peripheral face of the housing body; and
a tightening member crimping the electrical wire at the one side of the seal member, and including
an annular part pressing the insulating cover of the electrical wire by reducing the diameter of the annular part by crimping, the annular part being located inside the electrical wire guide part.

2. The connector as claimed in claim 1, wherein the tightening member includes a flange abutting from the other side onto a side face of the electrical wire guide part.

3. The connector as claimed in claim 1, further comprising an other side tightening member crimping the electrical wire at the other side of the seal member.

4. The connector as claimed in claims 3, wherein the electrical wire is a shield wire including a shield part disposed outside the insulating cover, and an outer insulating cover disposed outside the shield member, and further includes a conductive and tubular shield member connecting the seal member and the connection object, and wherein the other side tightening member is a pressure-bonding member crimping and fixing the shield member and the electrical wire.

5. The connector as claimed in claim 2, further comprising an other side tightening member crimping the electrical wire at the other side of the seal member.
